(19) United States
(12) Patent Application Publication
(10) Pub. No.: US 2005/0258239 A1
(43) Pub. Date: Nov. 24, 2005

(54) System method and program for purchasing merchandise

(75) Inventor: Shinichi Araki, Tokyo (JP)

Correspondence Address: GREENBLUM & BERNSTEIN, P.L.C., 1950 ROLAND CLARKE PLACE, RESTON, VA, 20191, US

(73) Assignee: DWANGO CO., LTD., Tokyo (JP)

(21) Appl. No.: 10/951,591

(22) Filed: Sep. 29, 2004

(30) Foreign Application Priority Data
May 19, 2004 (JP) 2004-149806

(51) Int. Cl. G06K 15/00

(52) U.S. Cl. 235/383

(57) ABSTRACT

The present invention provides a system, method and program for purchasing merchandise which one desires to purchase anonymously from a mobile terminal such as a mobile phone, via a campaign, and without using troublesome purchase methods. A user ID stored in a user information storage can be referred to in accordance with access by the mobile phone. In addition, the merchandise code of a purchase target can be specified by referring to a master information storage, and campaign money provided by others can be accepted. A campaign status storage stores content accepted by the campaign, the merchandise costs and the amount of money that needs to be collected. A server specifies the merchandise code of the desired merchandise from the campaign status storage, updates the amount of money that needs to be collected in accordance with the amount of money collected in the campaign, and purchases the merchandise when the amount of money collected reaches the cost of the merchandise.

The present invention relates to subject matter contained in Japanese Patent Application No. 2004-149806, filed on May 19, 2004 the disclosure of which is expressly incorporated herein by reference in its entirety.

### BACKGROUND OF THE INVENTION

1. Field of the Invention

The present invention relates to a system, method and program for purchasing merchandise.

2. Description of the Prior Art

A method for making a gift to a person by performing an online joint purchase has been recently proposed. As an example, a method is disclosed in Japanese Patent No. JP-A-2001-209678, which presents the price of merchandise and a period, recruits a person who desires to participate in the merchandise purchase, accepts a participating price and the name of the person, and decides the purchase of the merchandise in which the total amount of the participating price reaches the price of the merchandise.

In the above conventional example, since a present such as a gift is primary and a joint purchase is performed by accepting a person who desires to participate from friends or the like, anonymity is not maintained, and therefore it is difficult to promote the inducement of a campaign freely. When the Internet is used by a PC or the like, the registration of a bill payment method is troublesome when the joint purchase is performed, and, in this case, it is difficult to fully promote the inducement of the campaign freely.

### SUMMARY OF THE INVENTION

It is an object of the present invention to provide a system, method and program for purchasing merchandise which one desires to purchase anonymously from a mobile terminal such as a mobile phone, via a campaign, and without using troublesome purchase methods.

To solve the above problems and attain the above object, a merchandise purchase system for purchasing merchandise by using a mobile terminal in accordance with a first aspect of the present invention is provided.

The system includes a master information storage means for storing merchandise discrimination information specifying merchandise and merchandise information including merchandise costs, and a user information storage for storing mobile terminal user discrimination information specifying the mobile terminal of a user and communications address information of the user. The system also comprises a campaign purchase receiver for receiving user discrimination information stored in the user information storage upon access from the mobile terminal, specifying the merchandise discrimination information of merchandise to be purchased by reference to the master information storage, and accepting campaign money from others, and campaign status storage for storing content received by the campaign purchase receiver, the cost of the merchandise to be purchased and the amount of money that needs to be collected to complete the purchase. The system also comprises an updater for specifying the user discrimination information stored in the user information storage in accordance with access by the mobile terminal, specifying the merchandise discrimination information of a the merchandise to be purchased by reference to the campaign status storage means, and updating the amount of money that needs to be collected in the campaign status storage in accordance with an amount of campaign money collected, and a purchaser for purchasing the merchandise when the amount of campaign money collected by the updater reaches the cost of the merchandise.

In another aspect of the invention, the mobile terminal may be a mobile phone, and the purchase may be debited from a debit account for the charges of the mobile phone.

In another aspect of the invention, the updater may specify additional information other than information specifying the user supporting the campaign by referring to the campaign situation storage, to the mobile terminal receiving the support of the campaign, or to the portable terminal of the user supporting the campaign.

In another aspect of the invention, the updater may specify additional information other than information specifying the user supporting the campaign by referring to the campaign situation storage, to the mobile terminal receiving the support of the campaign, or to the portable terminal of the user supporting the campaign.

The merchandise purchase method of the present invention includes storing merchandise discrimination information specifying merchandise and merchandise information including the merchandise costs in a first memory, storing user information and communications address information in a second memory, specifying the user discrimination information stored in the second memory in accordance with access by a mobile terminal, specifying the merchandise discrimination information of merchandise to be purchased by referring to the first memory, and accepting campaign money from others. The method also includes storing the specified user information and merchandise information, the cost of the merchandise to be purchased and money that needs to be collected to complete the purchase in a third memory, specifying the user discrimination information stored in the second memory in accordance with access by the mobile terminal, specifying the merchandise discrimination information of the merchandise to be purchased by referring to the third memory, and updating the amount of money that needs to be collected in accordance with an amount of campaign money collected. The method also includes purchasing the merchandise when the amount of campaign money collected reaches the cost of the merchandise.

In another aspect of the invention, the mobile terminal may be a mobile phone, and the purchase is debited from a debit account for the charges of the mobile phone.

In another aspect of the invention, specifying may include specifying additional information other than information specifying the user performing the campaign by referring to the third memory, to the mobile terminal receiving the support of the campaign or the portable terminal of a user supporting the campaign.

In another aspect of the invention, the specifying may include specifying additional information other than information specifying the user performing the campaign by referring to the third memory, to the mobile terminal receiving the support of the campaign or to the portable terminal of the user supporting the campaign.

The merchandise program of the present invention contains code, which when executed by a server communicating with a mobile terminal, causes the server to perform operations including storing merchandise discrimination information and merchandise information including merchandise costs in a first memory, storing mobile terminal user information and communications address information in a second memory, specifying the user discrimination information stored in the second memory in accordance with access by the mobile terminal, specifying the merchandised is crimination information of merchandise to be purchased by referring to the first memory, and accepting campaign money from others. The operations also include storing the specified user information and merchandise information, the cost of the merchandise to be purchased and money that needs to be collected to complete the purchase in a third memory, specifying the user discrimination information stored in the second memory in accordance with access by the mobile terminal, and specifying the merchandise discrimination information of the merchandise to be purchased by referring to the third memory. The operations also include updating the amount of money that needs to be collected in accordance with an amount of campaign money collected, and purchasing the merchandise when the amount of campaign money collected reaches the cost of the merchandise.

In another aspect of the invention, the mobile terminal may be a mobile phone, and the purchase may be debited from a debit account for the charges of the mobile phone.

In another aspect of the invention, the specifying may include specifying information other than information specifying the user supporting the campaign is provided by referring to the third memory to the mobile terminal receiving the support of the campaign or to a portable terminal of a user supporting the campaign.

In another aspect of the invention, the specifying may include specifying information other than information specifying the user supporting the campaign is provided by the third memory to the mobile terminal receiving the support of the campaign or to a portable terminal of a user supporting the campaign.

### BRIEF DESCRIPTION OF THE DRAWINGS

FIG. 1 shows an example of a network system including a merchandise purchase system of the present embodiment;

FIG. 2 is a block diagram showing a configuration example of a server;

FIG. 3 illustrates information stored in a server;

FIG. 4 illustrates information stored in a server;

FIGS. 5A & 5B illustrate information stored in a server;

FIG. 6 is a block diagram showing a configuration example of a mobile phone;

FIGS. 7A, 7B & 7C illustrate display screens of the present embodiment;

FIGS. 8A, 8B, 8C & 8D illustrate display screens of the present embodiment;

FIGS. 9A, 9B & 9C illustrate display screens of the present embodiment;

FIG. 10 is a flow chart illustrating processing between a mobile phone and a server of the present embodiment;

FIG. 11 is a flow chart illustrating processing between a mobile phone and a server of the present embodiment;

FIG. 12 is a flow chart illustrating processing between a mobile phone and a server of the present embodiment;

FIG. 13 is a flowchart illustrating the processing between a mobile phone and a server of the present embodiment.

### DESCRIPTION OF THE PREFERRED EMBODIMENTS

Hereinafter, an embodiment of the present invention will be described in detail with reference to the accompanying drawings.

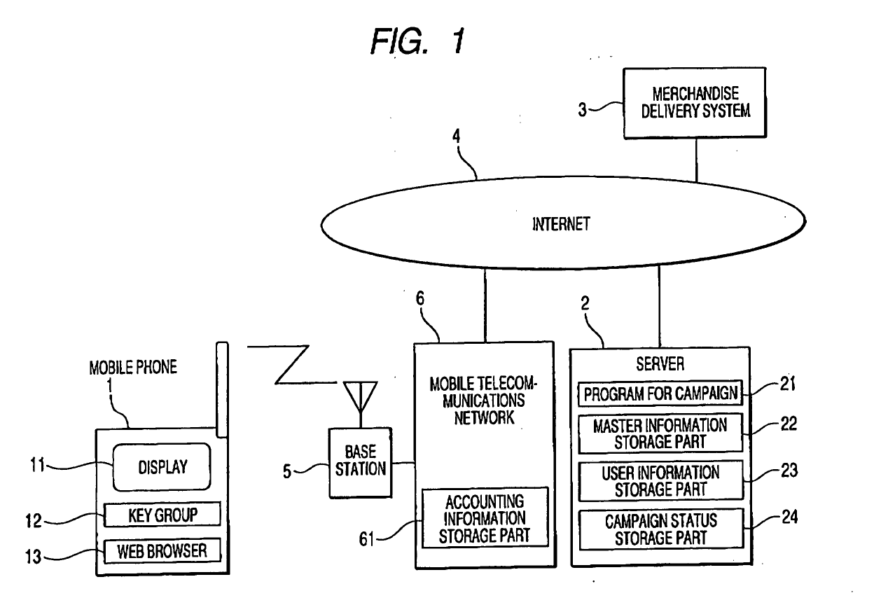

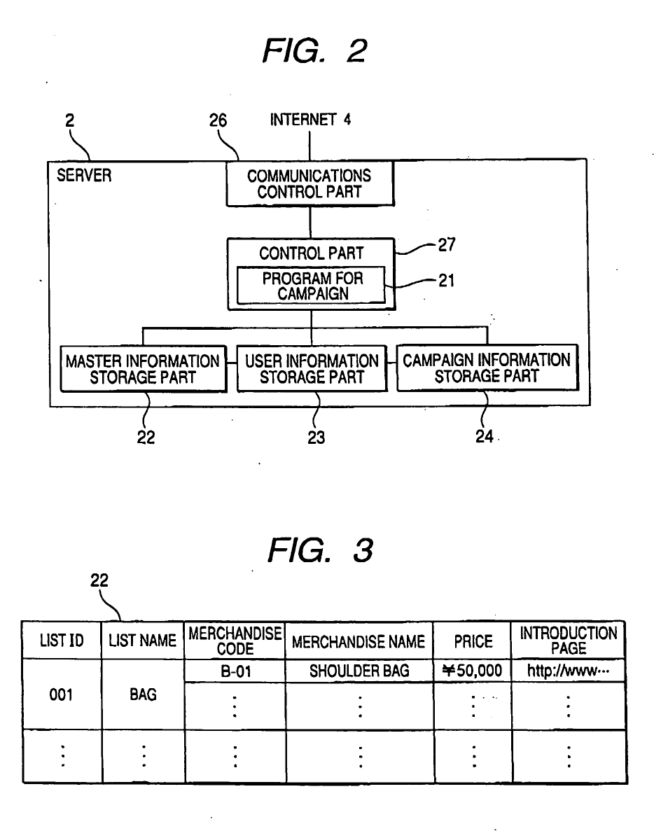

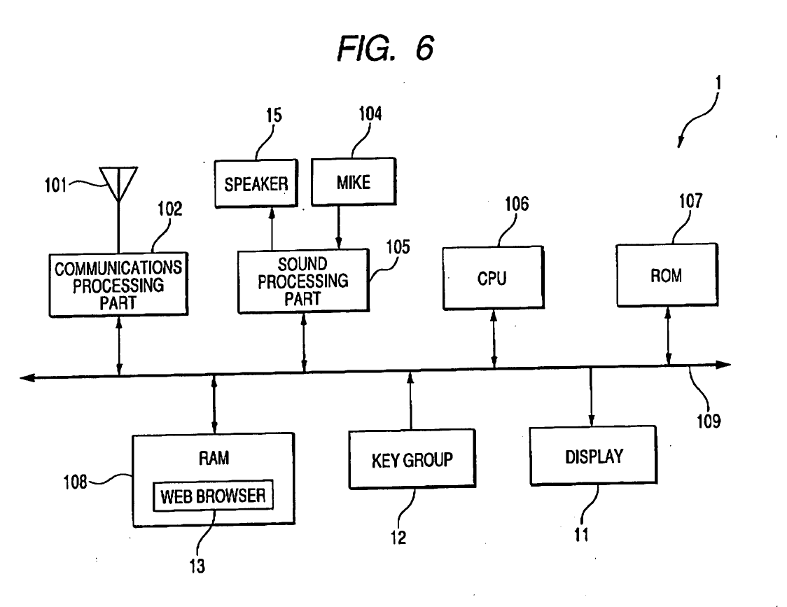

FIG. 1 shows an example of a network system including a merchandise purchase system of the present invention. FIG. 2 is a block diagram showing an example of a server configuration. FIG. 3 to FIG. 5 illustrate information stored in a server. FIG. 6 is a block diagram showing an example of a mobile phone configuration.

In FIG. 1, 1 designates a mobile phone, and 2 designates a server. Numeral 3 designates a merchandise delivery system, and 4 designates the Internet. Numeral 5 designates a base station, and 6 designates a mobile telecommunications network. The mobile telecommunications network 6, the server 2 and the merchandise delivery system 3 are connected with the Internet 4, and can communicate with one another. The mobile phone 1 can be connected with the Internet 4 via the base station 5 connected with the mobile telecommunications network 6. The mobile phone 1 is connected with the server 2 via the network, and can be used to purchase merchandise.

When the server 2 completes the procedures of the merchandise purchase between the mobile phone 1 (typical example) and the server 2, the server 2 can send merchandise orders to the merchandise delivery system 3. Herein, as shown in FIG. 1, the merchandise purchase system is realized by or embodied in the server 2. An accounting information storage part 61 provided in the mobile telecommunications network 6 performs an accounting processing. The account information for charging each user of a mobile phone (the user name and a bank account or the like) is stored in the accounting information storage part 61. The cost of the merchandise fixed in the present embodiment is withdrawn from the charging account of the mobile phone.

The mobile phone 1 can access the server 2 via the Internet 4. The mobile phone 1 is provided with a display 11 for displaying a Web page provided by the server 2, a key group 12 for performing input operations for accessing the Web page displayed on the display 11, and a Web browser 13 for displaying the page provided by the server 2 or the like.

As shown in FIG. 1, the server 2 is provided with a program 21 for a campaign, a master information storage part 22, a user information storage part 23, and a campaign situation storage part 24 or the like. Merchandise discrimination or description information specifying merchandise in accordance with the merchandise, and merchandise information including the purchased amount of the merchandise are stored in the master information storage part 22. Specifically, as shown in FIG. 3, a list name, merchandise code, merchandise name, a price and a URL of an introduction page of the merchandise are stored so as to be made to correspond to the list ID of the merchandise. For instance, when the list name is “bag,” the ID is 001. Several kinds of bags are listed, and the merchandise code B-01 is linked with the merchandise name “shoulder bag,” the price “¥50,000” and an introduction page.

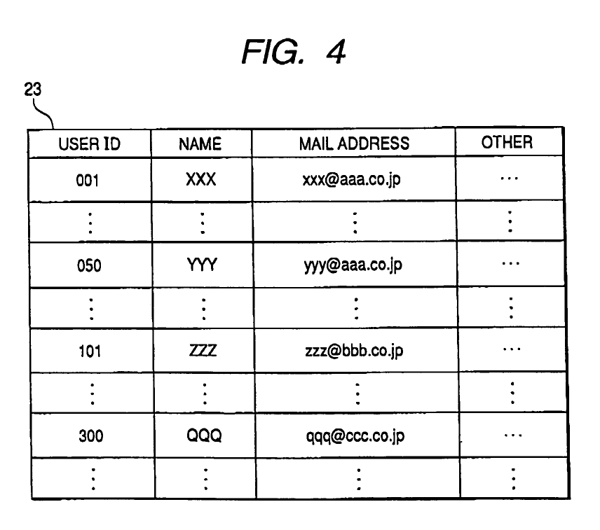

The user information storage part 23 stores user discrimination information specifying a mobile phone in accordance with a user, and communications address information of the user. Particularly, as shown in FIG. 4, the name, the mail address and other information (address and account number or the like) are stored in accordance with the user ID specifying the user. In FIG. 4, a user ID 001 corresponds to a name XXX and a mail address XXX@aaa.co.jp, and a user ID 050 corresponds to a name YYY and a mail address YYY@aaa.co.jp.

The user ID stored in the user information storage part 23 can be referred in accordance with access from the mobile phone in the present embodiment. In addition, the merchandise code of a purchase target can be specified by referring to the master information storage part 22, and campaign money requiring money support from others can be accepted. The campaign status storage part 24 stores the content accepted by the campaign, the purchased amount of the merchandise and the remainder of the money thereof. The server 2 specifies the merchandise code of the campaign target from the campaign status in the campaign status storage part 24, renews the remainder of the money of the campaign in accordance with the amount of money of the campaign, and shifts to the purchase procedures of the merchandise when the campaign money reaches the purchased amount.

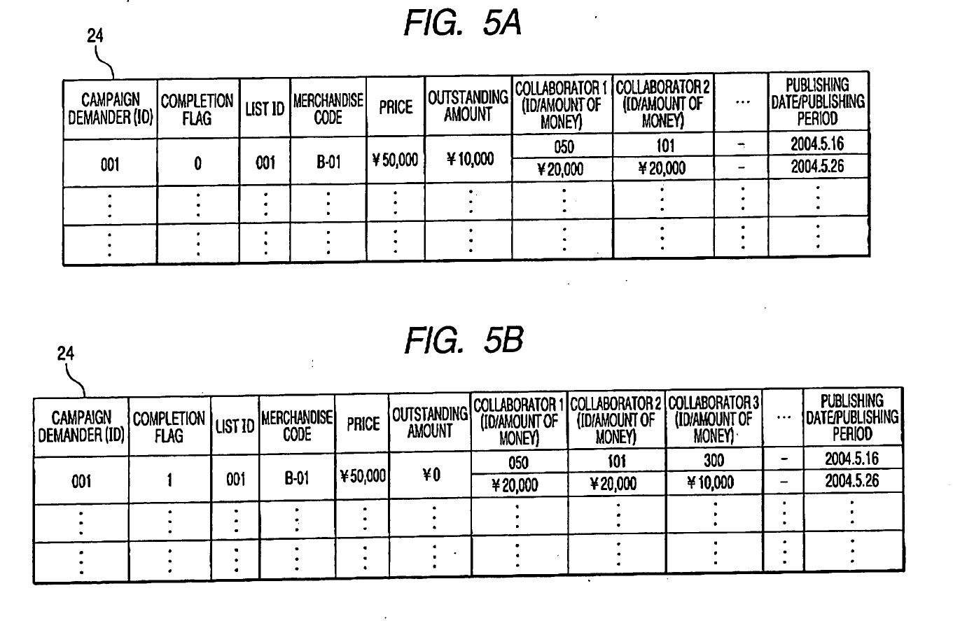

As shown in FIG. 5A, the campaign status storage part 24 stores: a completion flag (completion: 1, incompletion: 0) showing the completion or incompletion of a campaign in accordance with the ID of a user requesting the campaign, that is, a campaign demander; a list ID; merchandise code; price; the remainder of money obtained by subtracting the amount of the total of the campaign from the price of merchandise; campaign collaborators 1-N (N is a natural number); a date (publishing data) in which the campaign is published on the Internet; and a period (publishing period) which can be published.

In an example shown in FIG. 5A, an incomplete flag is set for a campaign demander ID001. At present, merchandise which demands a campaign contains the List of ID001, the merchandise code of B-01 and the price of ¥50,000 and the outstanding amount of ¥10,000. The collaborators are ID050 and ID101, and the campaign or contribution of ¥20,000 is received from the collaborators, respectively. The publishing date is May 16, 2004, and the publishing period is fixed to ten days. The calculation is performed from the next date, and the publishing expiration date is the 26th of the same month.

Next, the configuration of the mobile phone 1 will be described. An example of the configuration of the mobile phone 1 will be described in more detail by using FIG. 6. A communications processing part 102, a sound processing part 105, a CPU 106, ROM 107, RAM 108, a key group 12 or other input device, and a display 11 or the like are connected with an internal system bus 109. Thereby various kinds of processing can be performed by transmitting data, address signals, and control signals or the like.

The communications processing part 102 is connected with an antenna 101, and communicates with the mobile telecommunications network 6 via the antenna 101. Voice calling and communication with the server 2 can be realized by the communications processing part 102. A speaker l5 for voice output and a mic 104 for voice input are connected with the sound processing part 105, and the sound processing part 105 performs voice processing at the times of transmission and reception.

The CPU 106 controls the entire mobile phone 1 in accordance with an OS stored in the ROM 107. The ROM 107 stores preinstalled programs such as the OS. The CPU 106 controls the processing or the like of the present invention by using various mobile applications (for instance, a JAVA® application). The CPU 106 accepts an input from the key group 12, executes various processing, and controls the display 11 in accordance with the various processings.

The RAM 108 contains a work area or the like for storing contents such as a ring melody, and various data including a Web browser 13 for performing the communications of the present embodiment. The key group 12 contains various keys for inputting a telephone number and an address or the like, and inputting a service selection as is described below. The display 11 displays a picked up or received image, displays a guide screen for operating, or displays a general display when the function of a telephone and mail is used.

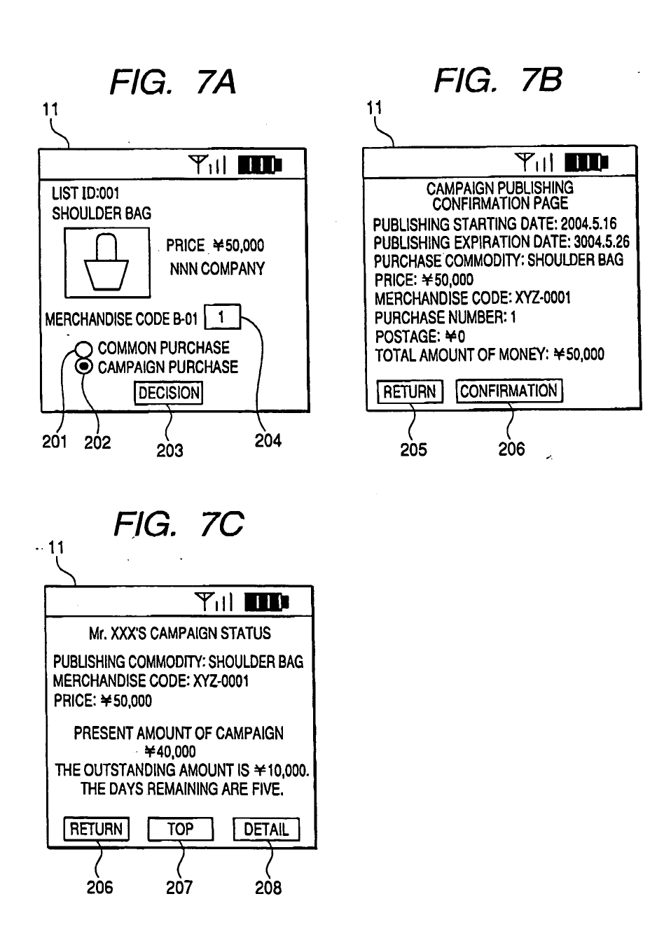

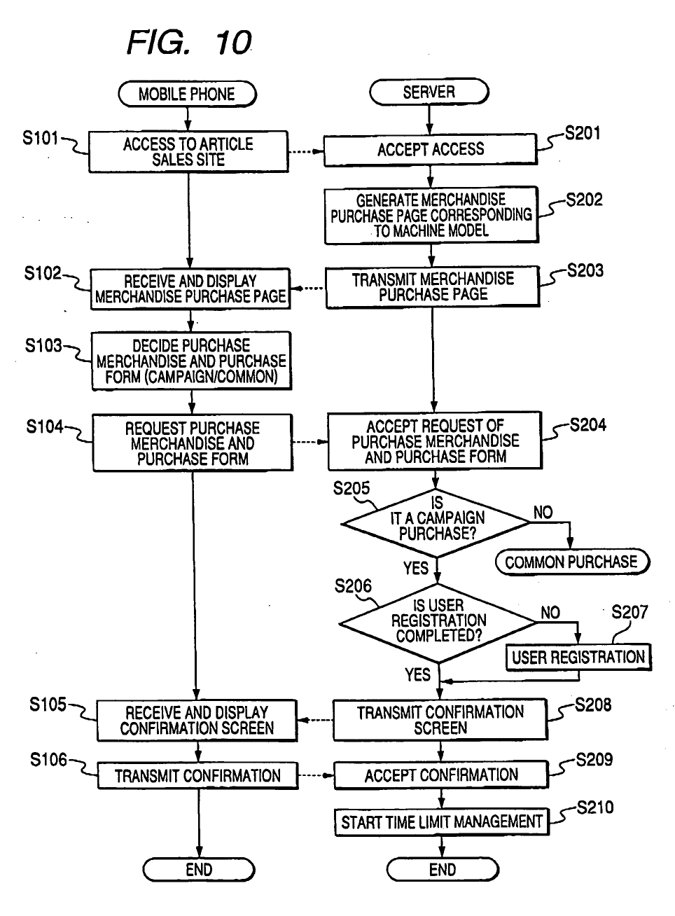

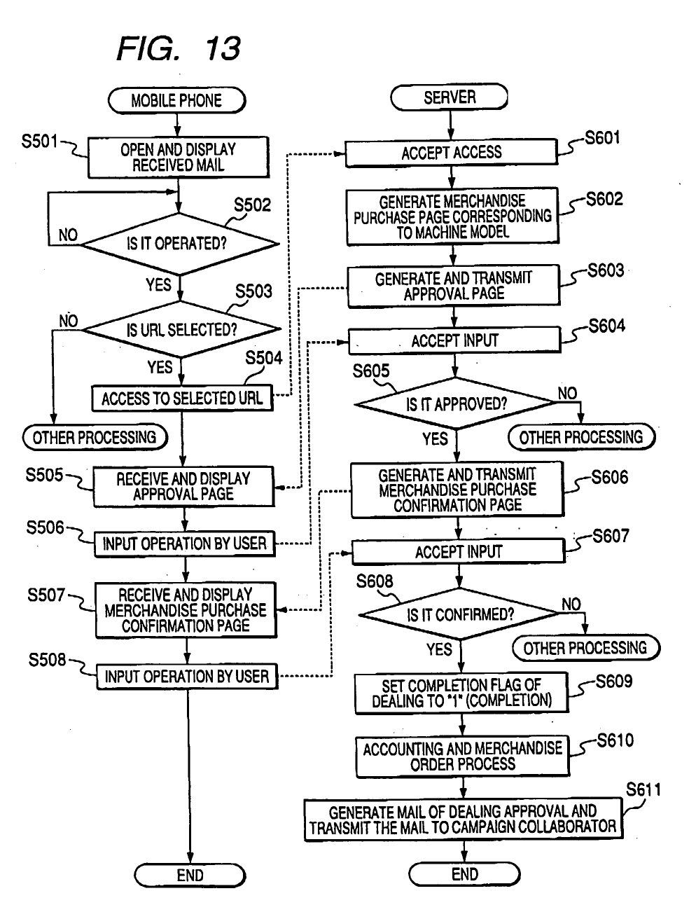

Next, the operation of the system will be described by using FIG. 7A to FIG. 13. FIG. 7A to FIG. 9C illustrate the display screens of the present invention. FIG. 10 to FIG. 13 are flow charts illustrating the processing between a mobile phone and a server according to the present invention.

When the mobile phone 1 attempts to access an article sales site (step S101), the access must be accepted by the server 2 (step S201). Once the access is accepted, the user ID is confirmed, and a merchandise purchase page corresponding to the mobile phone type is generated (step S202). When the merchandise purchase page is transmitted to the mobile phone 1 from the server 2 (step S203), the mobile phone 1 displays the page after it is received (step S102).

When the page of the desired merchandise is displayed, a page for confirming the purchase intent is displayed as shown in FIG. 7A. That is, when a page for a shoulder bag is displayed, the merchandise name, the list ID, the price and the photograph of the merchandise or the like are displayed as information relating to the merchandise. A purchase number setting column 204 and check columns 201 and 202 are provided. The purchase number setting column 204 sets the number of purchases. The check columns 201 and 202 select a typical purchase in which the purchase form is an ordinary purchase (i.e., without assistance) or a campaign purchase for purchasing the merchandise by requesting the campaign.

When the user selects the typical (or common) purchase or the campaign purchase, and operates the decision button 203 (step S103), the purchase merchandise and the purchase form or the like are transmitted to the server 2, and the information is accepted as a purchase request (step S204). When the user registration is completed at the time of the campaign purchase, the processing shifts to step S208. When the user registration is incomplete, the processing shifts to step S208 after shifting to the procedures of the user registration once. In cases other than the campaign purchase, usual processing is executed, and thus the explanation is omitted herein.

When the user registration is completed in the campaign purchase, the confirmation screen of the campaign publication is generated, and is transmitted to the mobile phone 1 (campaign client) (step S208). As shown in FIG. 7(B), the confirmation screen is formed on the mobile phone 1 (step S105) after receipt. When the user operates the confirmation button 206, the confirmation intention is transmitted to the server 2 as information (step S106). Of course, it is possible to return to the previous page, and, in that case, a return button 205 may be operated.

As described above, when the confirmation from the mobile phone 1 is accepted on the server 2 (step S209), the campaign situation is stored, and time limit management is started (step S210) as shown in FIG. 5A. Herein, the campaign client can confirm the campaign situation by accessing to the server 2 any time. As shown in FIG. 7C, it is possible to confirm the campaign situation from other than information of a person who has campaigned.

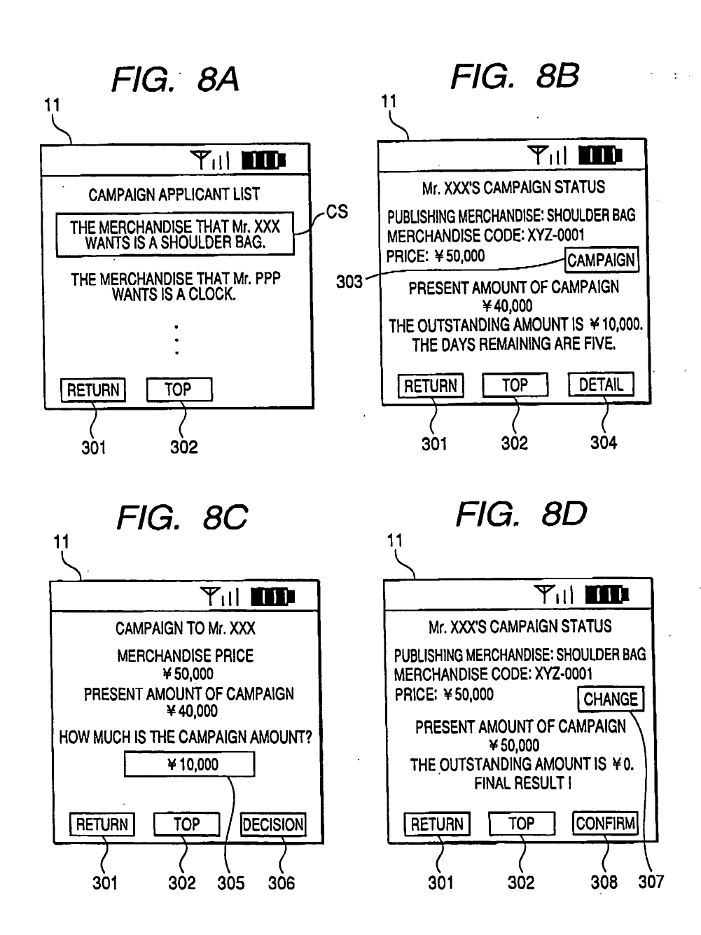

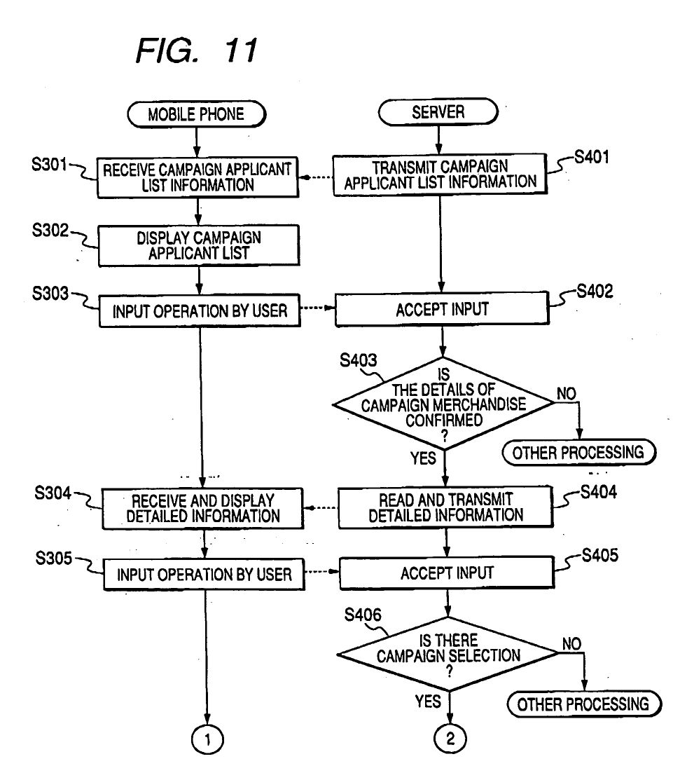

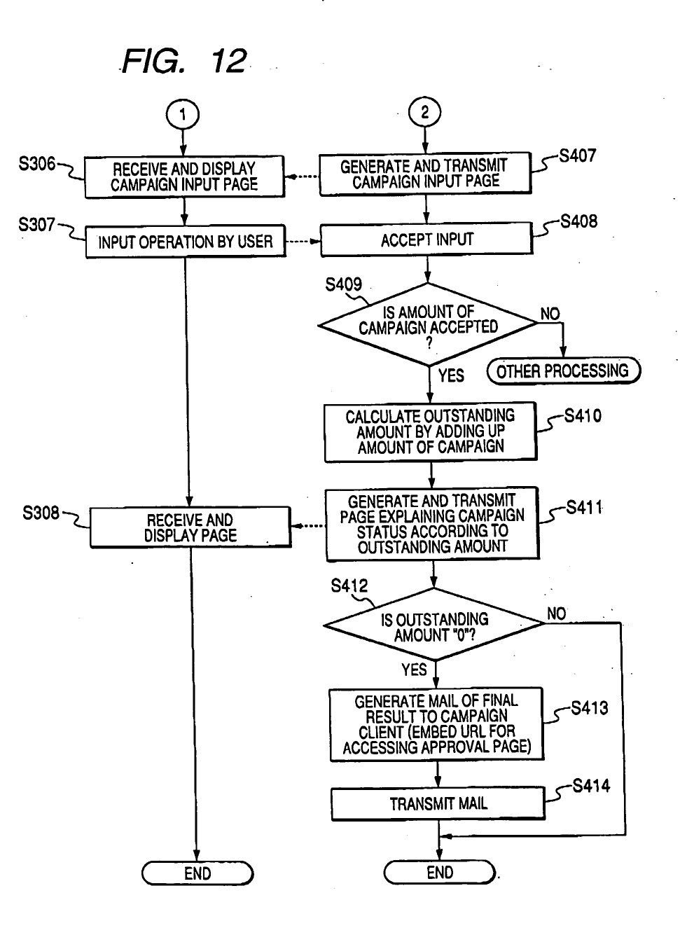

On the other hand, the processing from a person campaigning will be described in FIG. 8, FIG. 11, and FIG. 12. A campaign applicant can receive the campaign situation by accessing the server 2 from the mobile phone, and can inspect the list (step S301, S302, and step S401). As shown in FIG. 8A, when the list of the campaign applicant is displayed, the information position of the campaign applicant can be selected by the operation for moving a cursor CS.

When the cursor CS is moved to Mr. XXX, and the cursor location is decided or confirmed by the user operation (step S303), the server 2 accepts the input operation (step S402). In this case, information is read from the campaign situation storage part 24 so as to confirm the campaign merchandise in detail (YES route of step S403). The transmission is performed to the mobile phone of the demand originator of the detail information (step S404).

When the detail information of the mobile phone is received, the detail information is displayed on the display 11 (step S304). In this case, as shown in FIG. 8B, the outstanding amount and remaining days of the campaign in addition to the information of the merchandise are displayed. In addition, a campaign button 303 is provided, whereby the reception during the campaign can be shown.

The detail information of the merchandise can be inspected by a button 304, and can be moved to the top of the article sales site by a TOP button 302. Also, it is possible to return to a preceding page by using a return button 301.

In addition, when the user operates the campaign button 303 (step S305), the server 2 accepts the input operation (step S405), and a campaign input page is generated as a campaign selection (step S406). This page is transmitted to the mobile phone (step S407). When the campaign input page is received by the mobile phone, an amount of money setting column 305 for setting the amount of money of the campaign is displayed (step S306) as shown in FIG. 8C.

When the amount of money is set to the amount input column 305, and a decision button 306 is operated, the input amount of money is transmitted to the server 2 (step S307). When the input is accepted (step S408) in the server 2, the remainder of the amount of money of the campaign is calculated by referring to the campaign situation storage part 24 in an acceptance (YES route of step S409) of the amount of money of the campaign (step S410).

A page describing the campaign situation from the remainder of the money is generated, and is transmitted to the mobile phone (step S411). As a result, the mobile phone receives the page, and a message showing the final result is attached and displayed as the remainder of the money “0” (step S308) as shown in FIG. 8D. The amount of money can be changed in the mobile phone at this stage as long as a confirmation button 308 is not operated. The presence or absence of the completion is finally judged by the confirmation operation. The description is omitted in FIG. 12.

In the server 2, the remainder of the money is “0” (YES route of step S412), and thereby a mail of the final result is generated to the campaign client (step S413), and the mail is transmitted (step S414). Herein, a URL for accessing an approval page is embedded in the mail.

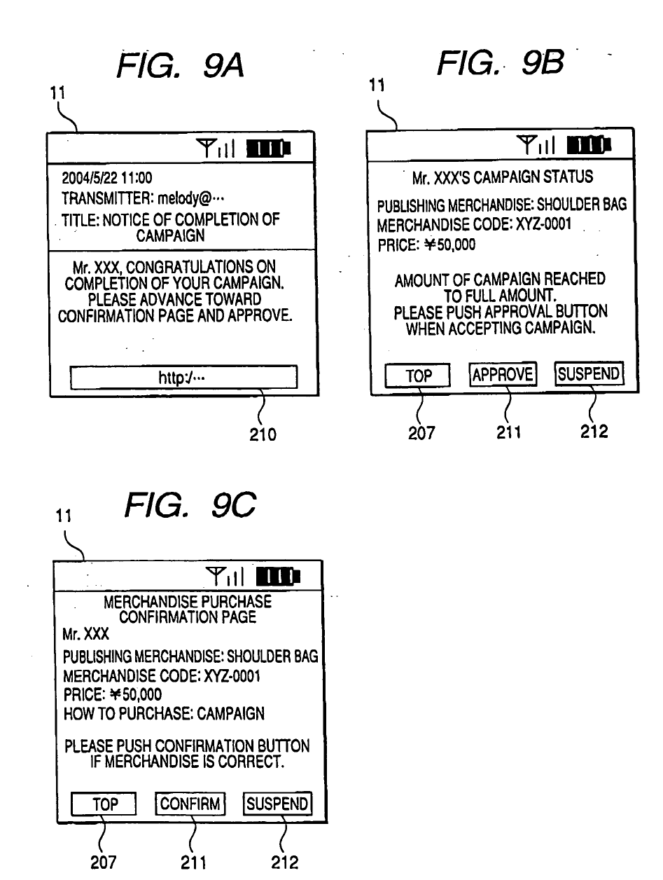

In the mobile phone 1, the mail reaches the campaign client, and is opened (step S501). When a URL 210 (see FIG. 9A) is selected (step S503) by the user's operation (step S502), the access to the URL is performed (step S504). In the server 2, the access from mobile phone 1 is accepted. When the approval page is an access destination (step S601), merchandise purchase page corresponding to the mobile phone model is generated, and in addition, an approval page is generated. This approval page is transmitted to the mobile phone 1 (step S603).

In the mobile phone 1, the approval page is received, and a final result situation, an approval button 211, a suspend button 212, and a TOP button 207 or the like are displayed as shown in FIG. 9B. When the approval button 211 is operated by the user's input operation, and the page is transmitted to the server 2 (step S506), an approval is confirmed (YES route of step S605) after the input is accepted by the server 2 (step S604), and merchandise purchase confirmation page is generated at this stage. The merchandise purchase confirmation page is transmitted to the mobile phone 1 (step S606).

When the merchandise confirmation page is received by the mobile phone 1, the merchandise confirmation page is displayed as shown in FIG. 9C. In this case, the page has the same function as that of a typical purchase confirmation, and the money is due to the campaign support. When the confirmation button 211 is operated, the transmission is performed to the server 2 (step S508). As a result, a transaction is established. Since the input is accepted in the server 2 (step S607), and the intention of the purchase confirmation is confirmed (YES route of step S608), the completion flag of the transaction is set to 1 from 0 in the campaign situation storage part 24 (step S609), and the processing of the account and merchandise order are executed (step S610) as shown in FIG. 5B. Afterwards, the thank you mail of the transmitting establishment generated is transmitted to the campaign collaborator (step S611). Thus, the campaign is established and anonymity is maintained.

As described above, with the present embodiment, the campaign for the merchandise that another desires to purchase anonymously from a mobile terminal such as a mobile phone, and being released from an annoying operations for paying the campaign price.

The present invention can be used in industries which manufacture merchandise purchase systems, merchandise purchase methods, merchandise purchase programs, as well as non-merchandise campaigns such as charity auctions, fundraisers, and the like.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

1. A merchandise purchase system for purchasing merchandise with a mobile terminal, comprising:
a master information storage for storing merchandise discrimination information specifying the merchandise and merchandise information including merchandise costs;
a user information storage for storing mobile terminal user discrimination information specifying the mobile terminal of a user and communications address information of the user;
a campaign purchase receiver for receiving the user discrimination information stored in the user information storage upon access from the mobile terminal, specifying the merchandise discrimination information of merchandise to be purchased by reference to the master information storage, and accepting campaign money from others;
a campaign status storage for storing content received by the campaign purchase receiver, the cost of the merchandise to be purchased and the amount of money that needs to be collected to complete the purchase;
an updater for specifying the user discrimination information stored in the user information storage in accordance with access by the mobile terminal, specifying the merchandise discrimination information of the merchandise to be purchased by reference to the campaign situation storage, and updating the amount of money that needs to be collected in the campaign status storage in accordance with an amount of campaign money collected; and
a purchaser for purchasing the merchandise when the amount of campaign money collected reaches the cost of the merchandise.

2. The merchandise purchase system as set forth in claim 1, wherein the mobile terminal is a mobile phone, and the purchase is debited from a debit account for the charges of the mobile phone.

3. The merchandise purchase system asset forth in claim 1, wherein the updater specifies additional information other than information specifying the user supporting the campaign by referring to the campaign status storage, to the mobile terminal receiving the support of the campaign, or to the portable terminal of the user supporting the campaign.

4. The merchandise purchase system as set forth in claim 2, wherein the updater specifies additional information other than information specifying the user supporting the campaign by referring to the campaign status storage, to the mobile terminal receiving the support of the campaign, or the portable terminal of the user supporting the campaign.

5. A merchandise purchase method for purchasing merchandise with a mobile terminal, comprising:
storing merchandise discrimination information specifying the merchandise and merchandise information including merchandise costs in a first memory;
storing mobile terminal user discrimination information and communications address information in a second memory;
specifying the user discrimination information stored in the second memory in accordance with access by the mobile terminal;
specifying the merchandise discrimination information of merchandise to be purchased by referring to the first memory;
accepting campaign money from others;
storing the specified user discrimination information, merchandise discrimination information, the cost of the merchandise to be purchased and money that needs to be collected to complete the purchase in a third memory;
specifying the user discrimination information stored in the second memory in accordance with access by the mobile terminal;
specifying the merchandise discrimination information of the merchandise to be purchased by referring to the third memory;
updating the amount of money that needs to be collected in accordance with an amount of campaign money collected; and
purchasing of the merchandise when the amount of campaign money collected reaches the cost of the merchandise.

6. The merchandise purchase method as set forth in claim 5, wherein the mobile terminal is a mobile phone, and purchase is debited from a debit account for the charges of the mobile phone.

7. The merchandise purchase method as set forth in claim 6, wherein specifying includes specifying additional information other than information specifying the user performing the campaign by referring to the third memory to the mobile terminal receiving the support of the campaign or to the portable terminal of a user supporting the campaign.

8. The merchandise purchase method as set forth in claim 5, wherein the specifying includes specifying additional information other than information specifying the user performing the campaign by referring to the third memory, to the mobile terminal receiving the support of the campaign, or the portable terminal of the user supporting the campaign.

9. A merchandise purchase program executed by a server communicating with a mobile terminal to carry out procedures for purchasing merchandise, the program containing code for performing the operations of:
storing merchandise discrimination information and merchandise information including merchandise costs in a first memory;
storing mobile terminal user discrimination information and communications address information in a second memory;
specifying the user discrimination information stored in the second memory with access by the mobile terminal;
specifying the merchandise discrimination information of merchandise to be purchased by referring to the first memory;
accepting campaign money from others;
storing the specified user discrimination information, the merchandise discrimination information, the cost of the merchandise to be purchased and money that needs to be collected to complete the purchase;
specifying the user discrimination information stored in the second memory in accordance with access by the mobile terminal;
specifying the merchandise discrimination information of the merchandise to be purchased by referring to the third memory;
updating the amount of money that needs to be collected in accordance with an amount of campaign money collected; and
purchasing the merchandise when the amount of campaign money collected reaches the cost of the merchandise.

10. The merchandise purchase program as set forth in claim 9, wherein the mobile terminal is a mobile phone, and the purchase is debited from a debit account for the charges of the mobile phone.

11. The merchandise purchase program as set forth in claim 10, wherein specifying includes specifying information other than information specifying the user supporting the campaign by referring to the third memory, to a mobile terminal receiving the support of the campaign, or to a portable terminal of a user supporting the campaign.

12. The merchandise purchase program as set forth in claim 9, wherein specifying includes specifying information other than information specifying the user supporting the campaign by referring to the third memory, to a mobile terminal receiving the support of the campaign, or to a portable terminal of a user performing the campaign.
